(19) United States
(12) Patent Application Publication
(10) Pub. No.: US 2009/0068301 A1
(43) Pub. Date: Mar. 12, 2009

(54) Protection Structure for an Optical Lens Module

(76) Inventor: Wen-Hua Huang, Tainan City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/851,726

(22) Filed: Sep. 7, 2007

(51) Int. Cl. B29C 47/94

(52) U.S. Cl. 425/107

(57) ABSTRACT

A protection structure for an optical lens module includes a female die, a male die, and an ejector plate. The male die includes a plurality of cores and second cavities. Locating rings are provided on the cores or in the second cavities to protect the cores from tearing and wearing so as to extend their lifespan.

### BACKGROUND OF THE INVENTION

1. Field of the Invention

The present invention relates to a protection structure of an optical lens module, and more particularly to one having locating rings provided between cores and second cavities of a male die so as to protect the cores from being worn easily.

2. Description of the Related Prior Art

A conventional module for optical lens, as shown in FIG. 13, comprises a male die A and a female die A5. The male die A comprises a roller bearing A1 a core A2. Both the roller bearing A1 and the core A2 are in post shape and secured in a hole A3. The roller bearing A1 is provided with a number of balls A4 therein. One side of the roller bearing A1 engages with the inner wall of the male die A, and the other side of the roller bearing A1 engages with the outer wall of the core A2. One end of the core A2 has a cutting section A21 matching with a plane A31 of the male die A and corresponding to a plane A52 of a cutting section A51 of the female die A5. The cutting section A51 and the plane A52 correspond to the cutting section A21 and the plane A31 to form a cavity.

The balls A4 of the roller bearing A1 may be in different sizes during producing procedure. The more balls A4, the more differences there will be. If the optical lens are made in oval or any other shapes but round shapes, the shapes of the roller bearings A1 and the core A2 have to be changed to accommodate the oval shape of the optical lens. This increases the cost of manufacture.

### SUMMARY OF THE INVENTION

According to the present invention, there is provided a protection structure for an optical lens module comprising a female die, the female die having a plurality of first cavities therein, each of the first cavities being provided with a female mold block; a male die, the male die having a plurality of cores and second cavities corresponding in position and in number to the first cavities of the female die, the second cavities being adapted for insertion of the cores; an ejector plate, the ejector plate having holes corresponding in position and in number to the second cavities of the male die, a plurality of guide rods and springs being provided between the male die and the ejector plate; and characterized by that locating rings are provided between the second cavities and the cores of the male die, and a lubricating member is provided on each of the locating rings.

It is the primary object of the present invention to provide a protection structure for an optical lens module, which eliminates direct contact of the cores with the first cavities and the second cavities, thus extending the lifespan of the module as well as increasing the engagement of the locating rings and the second cavities to make the manufacture more precise.

It is another object of the present invention to provide a protection structure for an optical lens module, which provides locating rings and lubricating members in accordance with the cores in different size or in different shape.

It is a further object of the present invention to provide a protection structure for an optical lens module, which provides a lubricating member to minimize friction of the cores.

It is another further object of the present invention to provide a protection structure for an optical lens module, which provides a supporting unit to sustain the ejector plate so that the cores will not be deformed under the pressure easily, which also maintains the cores in a horizontal status constantly.

### BRIEF DESCRIPTION OF THE DRAWINGS

FIG. 1 is an exploded view of a first embodiment of the present invention;

FIG. 2 is a perspective view of a core of the first embodiment of the present invention;

FIG. 3 is a cross-sectional view of the first embodiment of the present invention;

FIG. 4 is a cross-sectional view of the first embodiment of the present invention in operating stats;

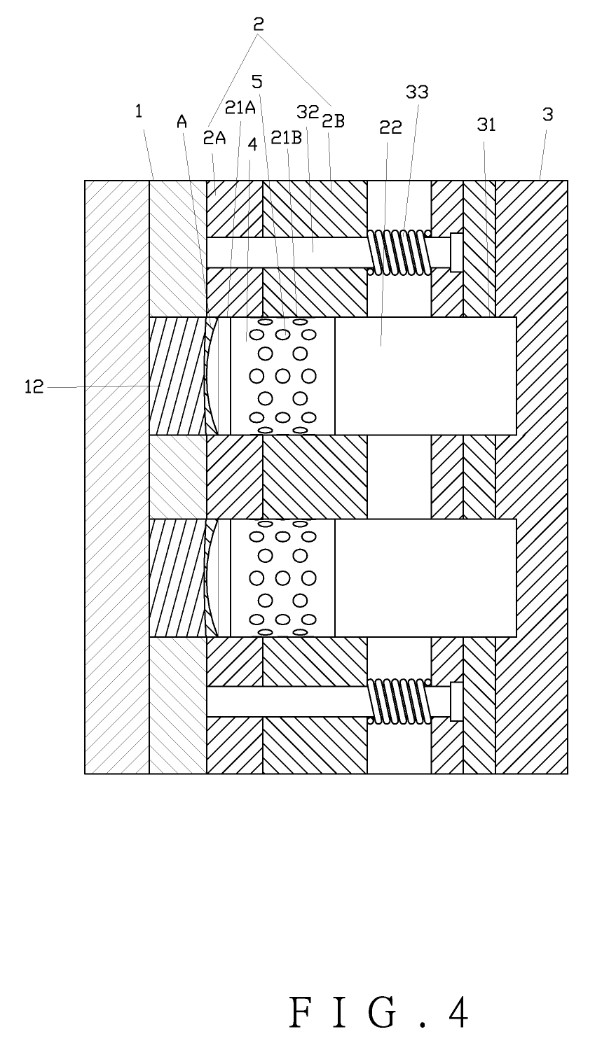

FIG. 5 is a perspective view of a male die and locating members of a second embodiment of the present invention;

FIG. 6 is a cross-sectional view of the second embodiment of the present invention;

FIG. 7 is a perspective view of a core of a third embodiment of the present invention;

FIG. 8 is a perspective view of a male die provided with inserting blocks of a fourth embodiment of the present invention;

FIG. 9 is a perspective view of a core of a fifth embodiment of the present invention;

FIG. 10 is a perspective view of a male die provided with inserting blocks of a sixth embodiment of the present invention;

FIG. 11 is a side view of the present invention showing a supporting unit;

FIG. 12 is a side view of the present invention in operating status; and

FIG. 13 is a cross-sectional view of the prior art.

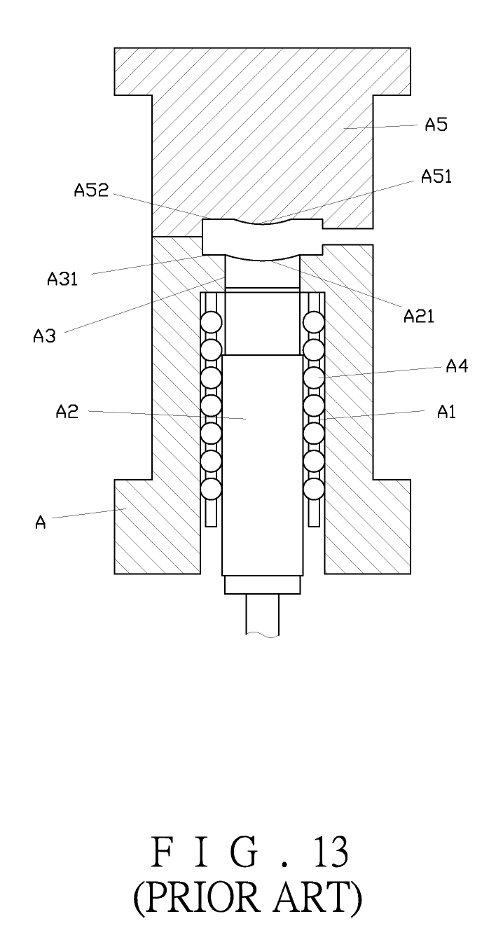

### DETAILED DESCRIPTION OF THE PREFERRED EMBODIMENTS

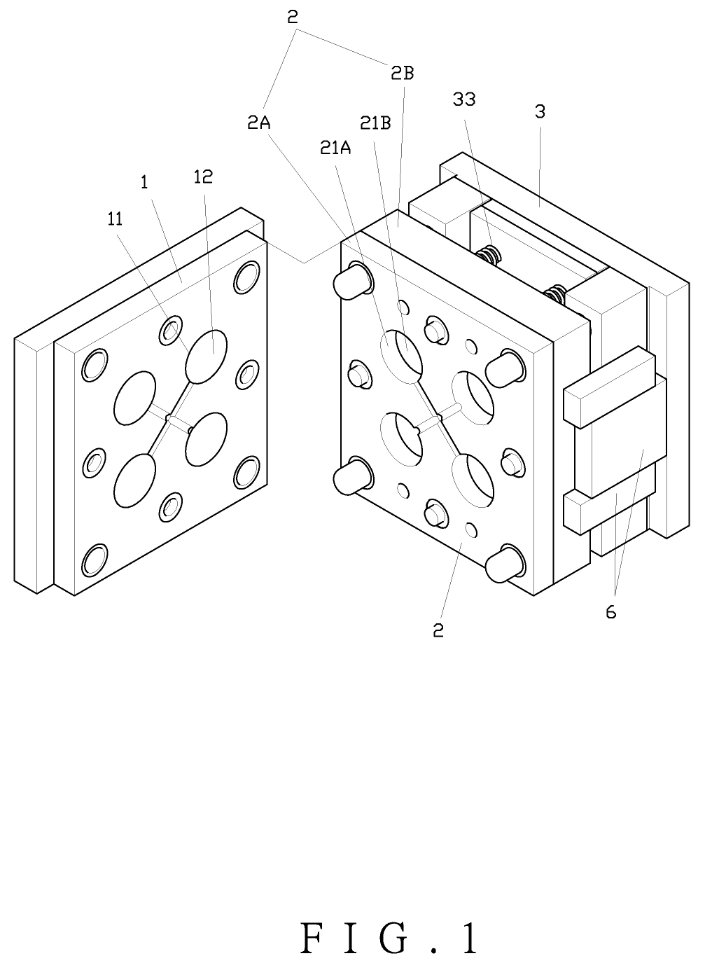

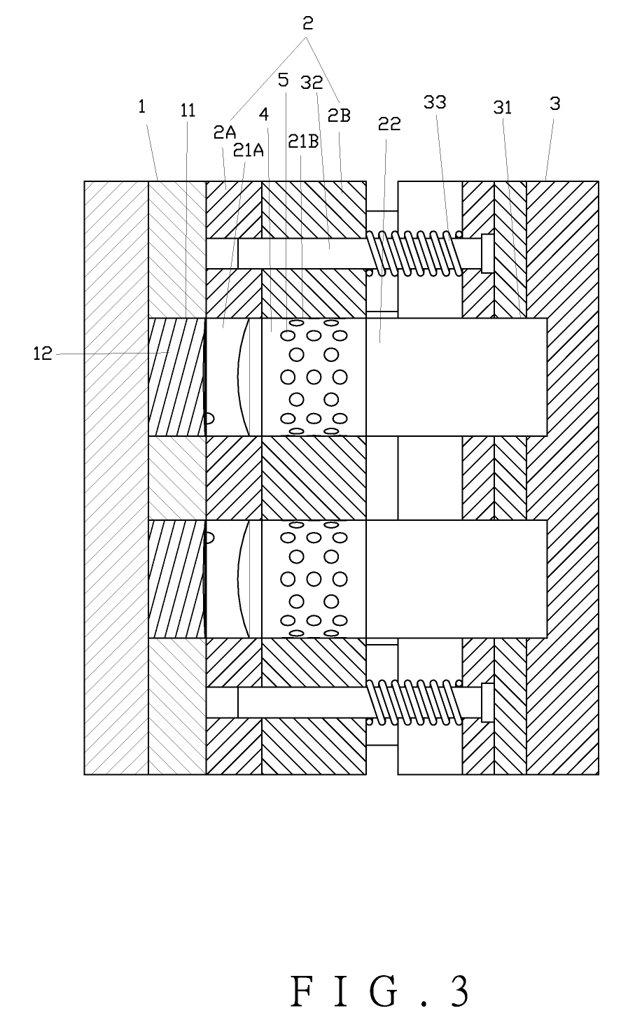

As shown in FIGS. 1 and 3, a first preferred embodiment of the present invention comprises a female die 1, a male die 2, an ejector plate 3, and locating rings 4.

The female die 1 is formed with a plurality of first cavities 11. Each first cavity 11 is provided with a female mold block 12 therein.

The male die 2 comprises a movable mode plate 2A, a retaining plate 2B and a plurality of cores 22. The movable mode plate 2A and the retaining plate 2B are formed with a plurality of second cavities 21A and third cavities 21B corresponding in position and in number to the first cavities 11 of the female die 1. The second cavities 21A and the third cavities 21B are adapted for insertion of the cores 22.

The ejector plate 3 is formed with a plurality of holes 31 corresponding in position and in number to the second cavities 21A and third cavities 21B of the male die 2 for securing the cores 22. The ejector plate 3 further comprises guide rods 32 and springs 33 located between the male die 2 and the ejector plate 3.

Each of the locating rings 4 is disposed between the second cavity 21A and the third cavity 21B of the male die 2 and the core 22.

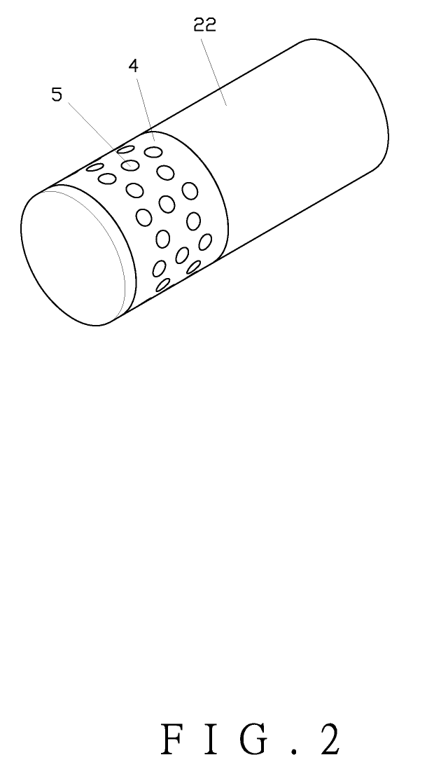

As shown in FIGS. 2 and 3, the locating ring 4 is disposed on the core 22, corresponding in position to the second cavity 21A and the third cavity 21B of the male die 2. The locating ring 4 has an outer diameter slightly larger than that of the core 22 and is tightly attached on the core 22. A lubricating member 5 is provided on the locating ring 4.

A supporting unit 6 is externally provided on the male die 2 and the ejector plate 3.

As shown in FIG. 3 the male die 2 remains a distance with the ejector plate 3, and the cores 22 remains a distance from the first cavities 11 of the female die 1. To operate the present invention, pour raw material A into the module, and then push the ejector plate 3 towards the male die 2, which links the guiding rods 32, the cores 22 towards the first cavities 11 of the female die 1 and compresses the springs 33. The raw material A will then be forged to the shape by the cores 22.

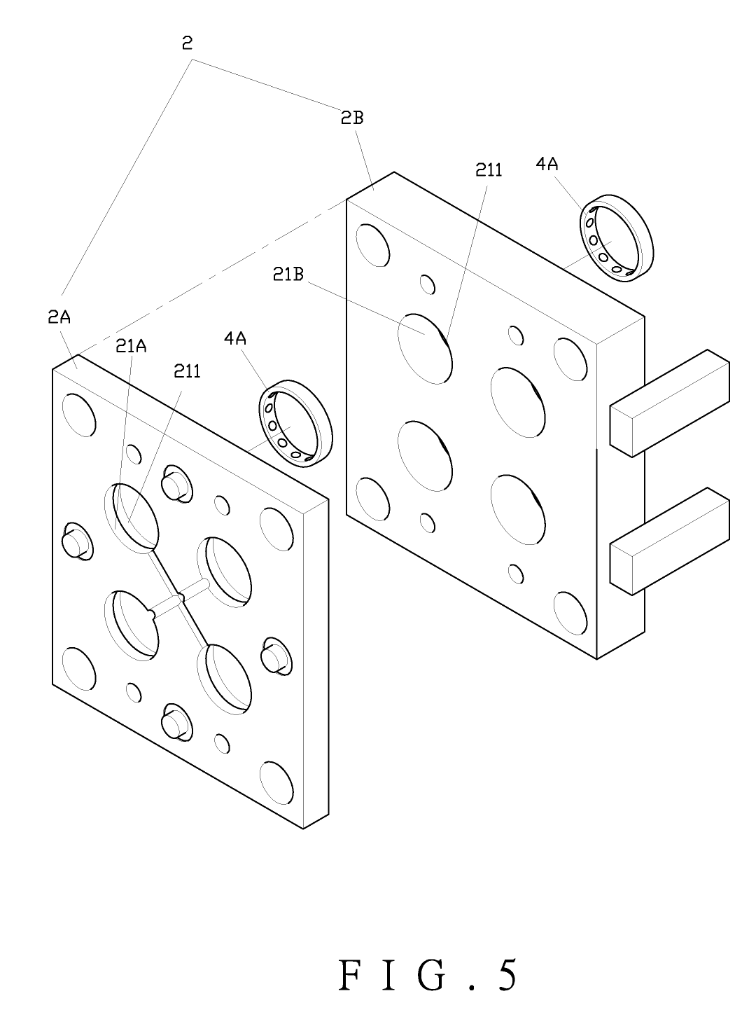

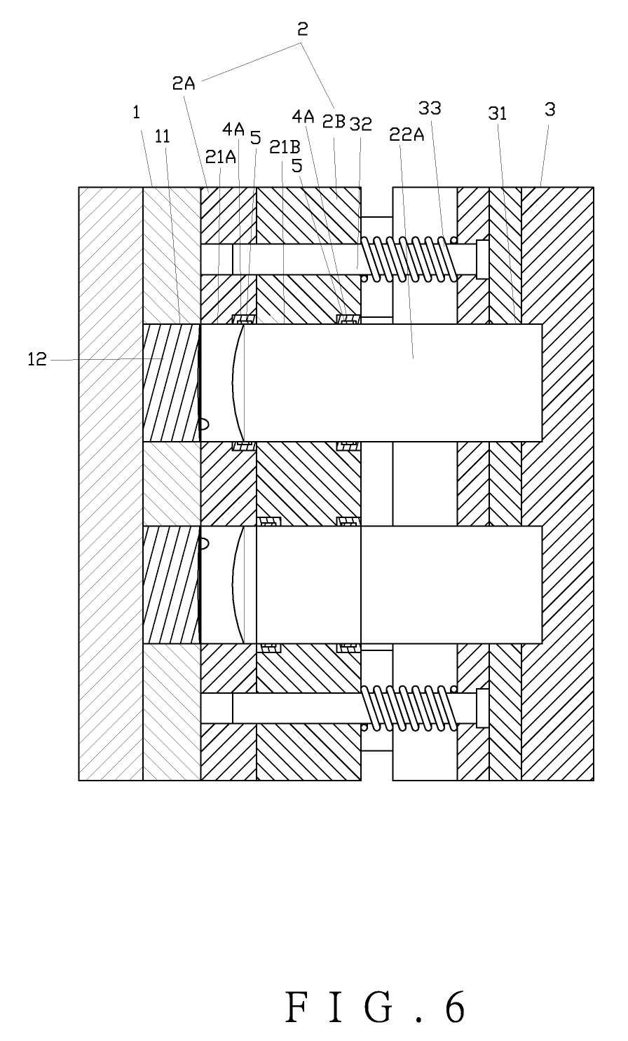

FIGS. 5 and 6 show a second embodiment of the present invention. The second cavities 21A and the third cavities 21B of the male die 2 are formed with recesses 211, respectively. A locating ring 4A is provided in each of the recesses 211 of the second cavities 21A and the third cavities 21B of the male die 2. The locating ring 4A has an inner diameter slightly smaller than those of the second cavity 21A and the third cavity 21B. The locating ring 4A is tightly secured in the recess 211. The lubricating member 5 is provided in the locating ring 4A.

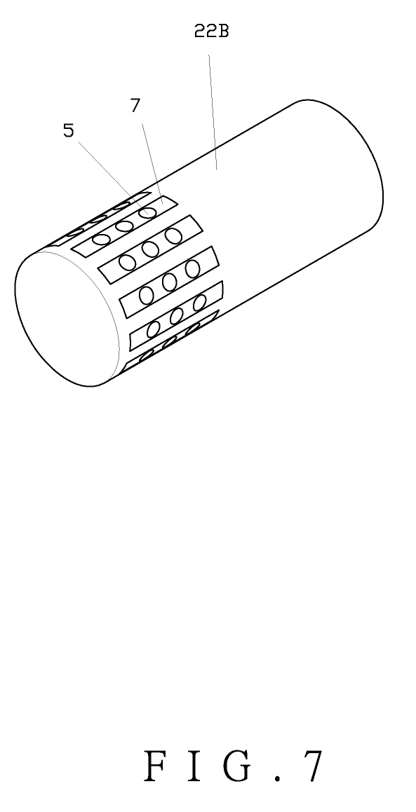

FIG. 7 shows a third embodiment of the present invention. A core 22B is provided with a plurality of inserting blocks 7 thereon corresponding in position to the second cavity 21A and the third cavity 21B. Each of the inserting blocks 7 has an outer diameter slightly larger than that of the core 22B. The lubricating member 5 is provided on each of the inserting blocks 7.

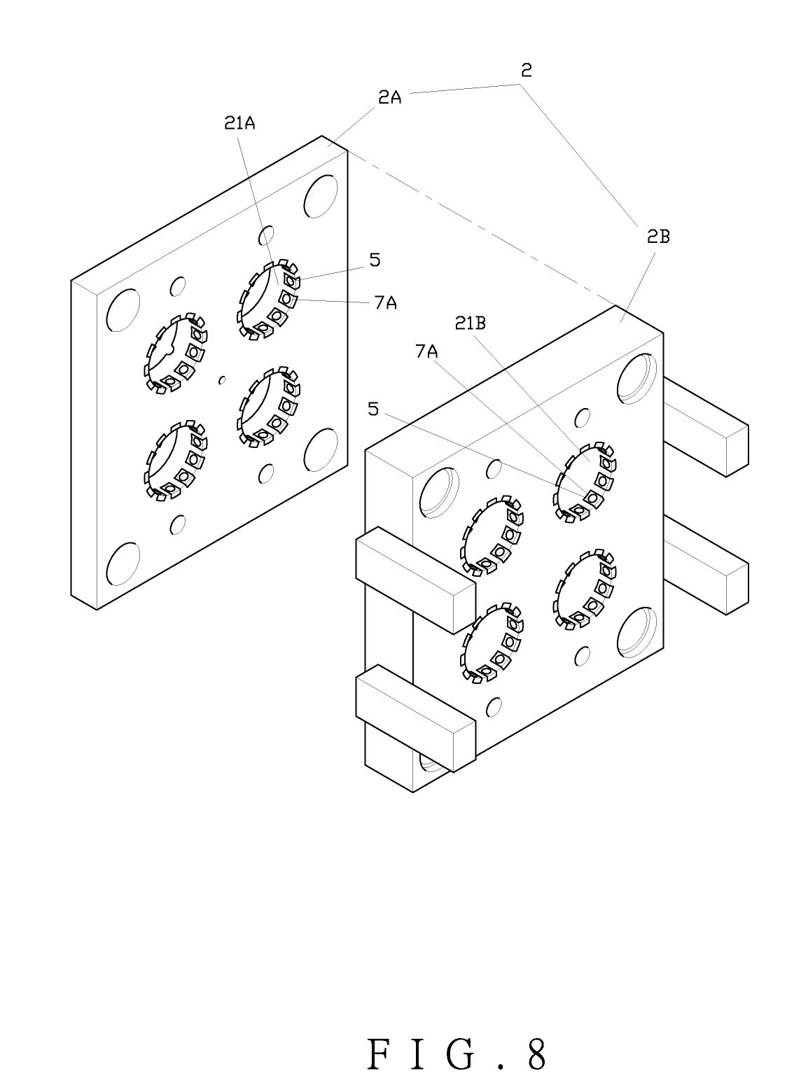

FIG. 8 shows a fourth embodiment of the present invention. Inserting blocks 7A are provided around inner walls of the second cavities 21A and the third cavities 21B. The lubricating member 5 is provided on each of the inserting blocks 7A.

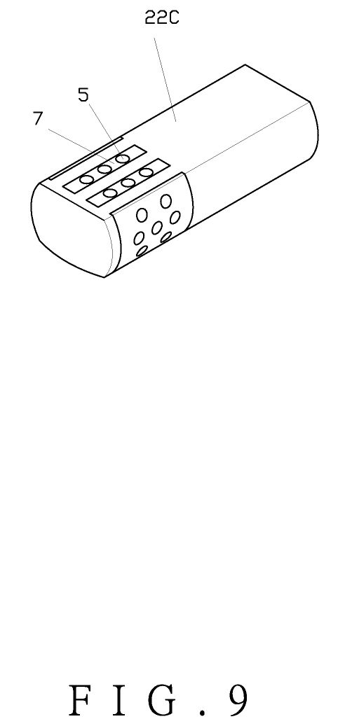

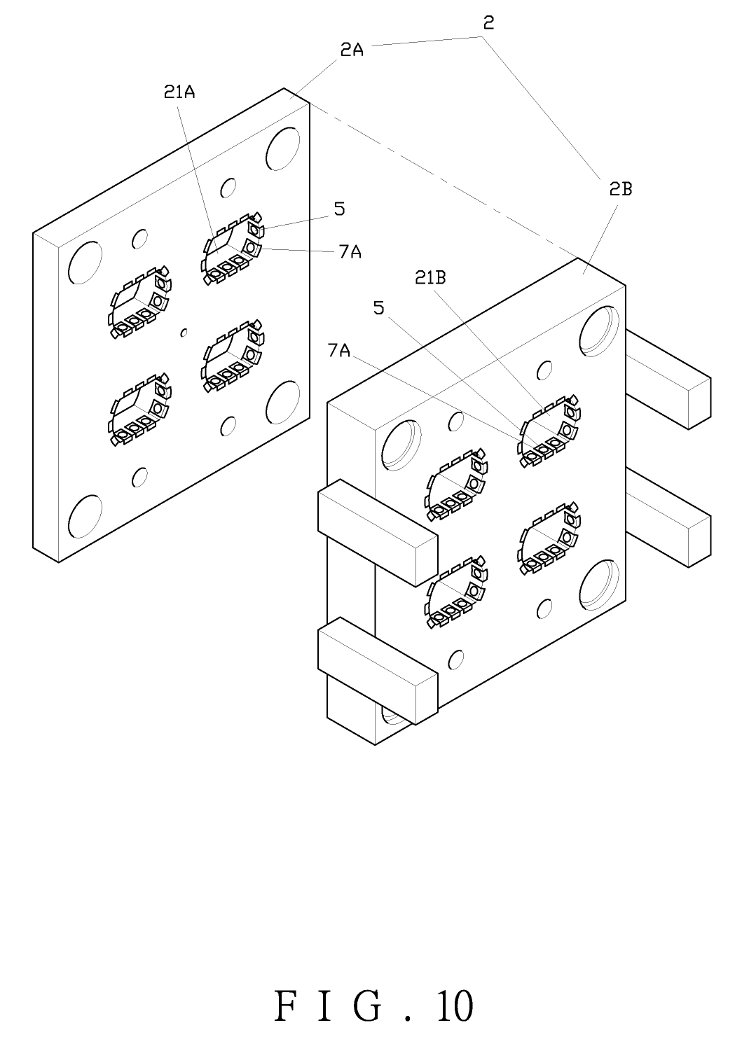

FIGS. 9 and 10 show a fifth embodiment and a sixth embodiment of the present invention. The first cavities 11, the second cavities 21A, the third cavities 21B, and the cores 22C are all made in oval-like shape. The shape of the core 22C is not limited. The inserting blocks 7A are provided on the core 22C corresponding in position to the second cavity 21A and the third cavity 21B, or the inserting blocks 7A are provided in each of the second cavities 21A and the third cavities 21B of the male die 2. The lubricating member 5 is provided on each of the inserting blocks 7 and 7A.

The lubricating member 5 on the locating rings 4, 4A and the inserting blocks 7, 7A is made of either Graphite or polytetrafluoroethylene (PTFE) material. The lubricating member 5 bulges out slightly from the locating rings 4, 4A, and the inserting blocks 7, 7A and can be contact with the first cavity 11 of the female die 1, the second cavity 21A and the third cavity 21B of the male die 2 when operating, producing lubricating effect.

The cores 22, 22A, 22B and 22C may be either with or without the lubricating member 5, extending their service life. However, with the lubricating member 5, the lifespan may be even longer. The locating rings 4, 4A and the inserting blocks 7, 7A is made of polytetrafluoroethylene (PTFE) material, providing a wearable character and lubricating effect.

Furthermore, during installation, the welding process may cause the locating rings 4, 4A and the inserting blocks 7 and 7A to deform and their sizes may be larger than they are designed. For instance, the locating ring 4 is composed of two halves secured on the core 22 and welded together. After the weld, the outer diameter of the locating ring 4 is larger than the inner diameters of the second cavity 21A and the third cavity 21B of the male die 2, but a modification on the locating ring 4 will shrink the diameter until the size of the locating ring 4 conforms to the most desirable measurement.

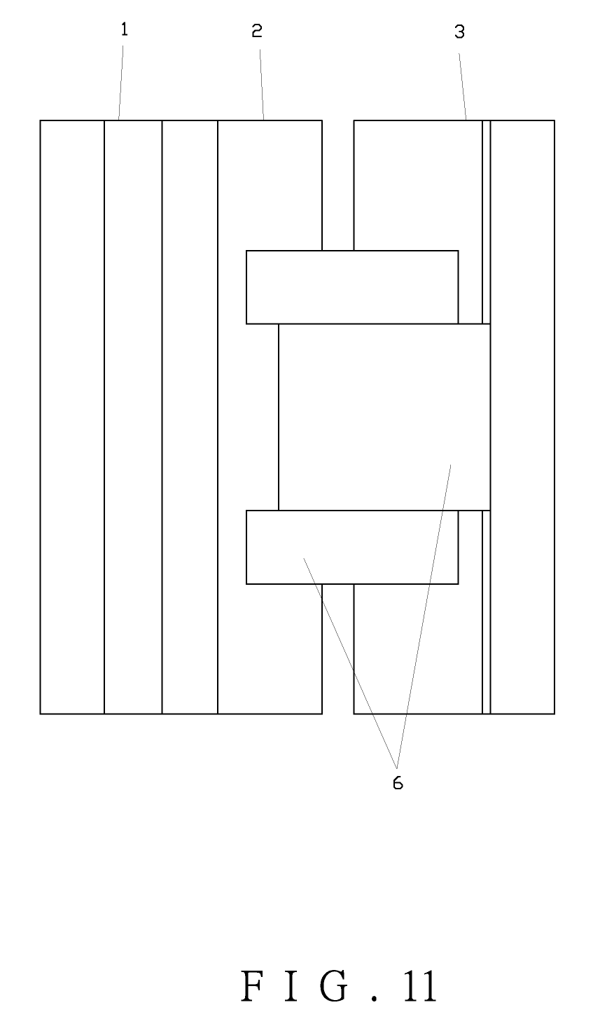

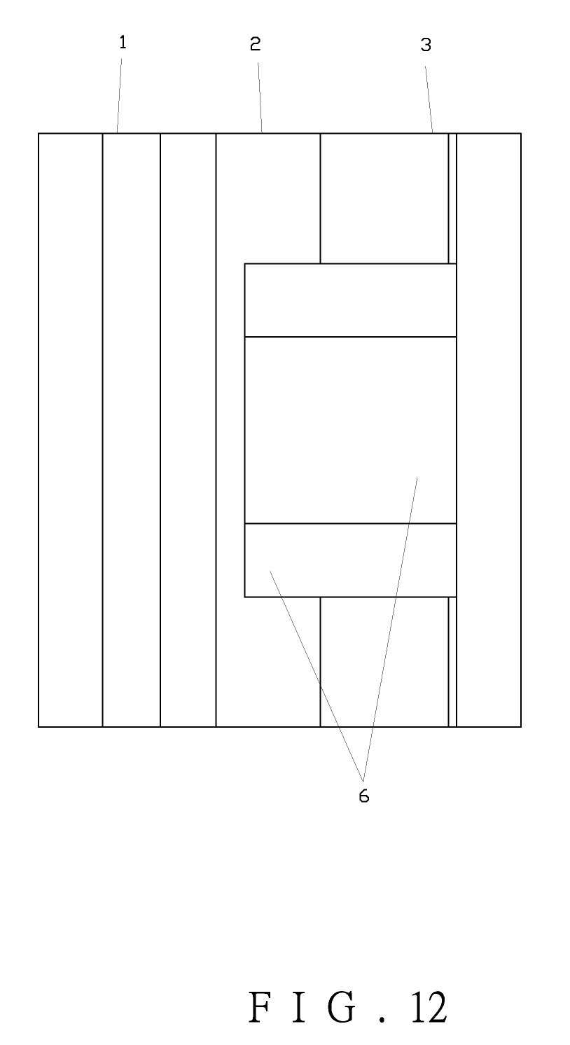

As shown in FIGS. 11 and 12, the supporting unit 6 externally provided on the male die 2 and the ejector plate 3 provides a supporting effect and facilitates the reciprocation of the cores 22, 22A, 22B, ad 22C without producing noise and extending the service life.

What is claimed is:

1. A protection structure for an optical lens module comprising:
a female die, the female die having a plurality of first cavities therein, each of the first cavities being provided with a female mold block;
a male die, the male die having a plurality of cores and second cavities corresponding in position and in number to the first cavities of the female die, the second cavities being adapted for insertion of the cores;
an ejector plate, the ejector plate having holes corresponding in position and in number to the second cavities of the male die, a plurality of guide rods and springs being provided between the male die and the ejector plate; and characterized by that:
locating rings are provided between the second cavities and the cores of the male die, and a lubricating member is provided on each of the locating rings.

2. The protection structure for an optical lens module, as recited in claim 1, wherein the locating ring is disposed on the core corresponding in position to the second cavity of the male die, and the locating ring has an outer diameter slightly larger than that of the core.

3. The protection structure for an optical lens module, as recited in claim 1, wherein the locating ring is disposed in the second cavity of the male die, and the locating ring has an inner diameter slightly smaller than that of the second cavity.

4. The protection structure for an optical lens module, as recited in claim 1, wherein the locating ring is made of polytetrafluoroethylene (PTFE) material.

5. The protection structure for an optical lens module, as recited in claim 1, wherein the lubricating member is made of polytetrafluoroethylene (PTFE) material.

6. The protection structure for an optical lens module, as recited in claim 1, wherein said lubricating member is made of graphite material.

7. The protection structure for an optical lens module, as recited in claim 1, wherein the locating ring is provided with a plurality of inserting blocks.

8. The protection structure for an optical lens module, as recited in claim 7, wherein the inserting blocks are made of polytetrafluoroethylene (PTFE) material.

9. The protection structure for an optical lens module, as recited in claim 7, wherein a lubricating member is provided on each of the inserting blocks.

10. The protection structure for an optical lens module, as recited in claim 9, wherein the lubricating member is made of polytetrafluoroethylene (PTFE) material.

11. The protection structure for an optical lens module, as recited in claim 9, wherein the lubricating member is made of graphite material.

12. The protection structure for an optical lens module, as recited in claim 1, wherein a supporting unit is externally provided on the male die and the ejector plate.

13. The protection structure for an optical lens module, as recited in claim 1, wherein the male die comprises a moveable mode plate and a retaining plate, the moveable mode plate having the second cavities and the retaining plate having third cavities.
